(19) United States
(12) Patent Application Publication
(10) Pub. No.: US 2026/0276386 A1
(43) Pub. Date: Sep. 17, 2026

(54) METHODS AND SYSTEMS FOR PROVIDING A POSITION OF A TRANSPORTATION VEHICLE TO DISPLAY AT A SEAT IN THE TRANSPORTATION VEHICLE

(71) Applicant: Panasonic Avionics Corporation, Irvine, CA (US)

(72) Inventors: Sanjiv Pimple, Tustin, CA (US); Philip Watson, Lake Forest, CA (US)

(21) Appl. No.: 19/077,470

(22) Filed: Mar. 12, 2025

(51) Int. Cl. G01C 21/20; G07C 5/00; H04L 67/12

(52) U.S. Cl. CPC G01C 21/20; G07C 5/008; H04L 67/12

(57) ABSTRACT

Methods and systems are provided for providing a position of a transportation vehicle by a seat electronic device associated with at least one seat in the transportation vehicle. One method includes receiving travel information associated with the transportation vehicle, where the travel information is received from at least one of a location estimation device coupled to the seat electronic device, an external device independent from the transportation vehicle, or at least one second seat electronic device of multiple seat electronic devices. The method further includes determining position information including a current position of the transportation vehicle based on the travel information and transmitting the position information of the transportation vehicle to a display device to display the position information on the display device, where the seat electronic device is included in the multiple seat electronic devices connected to one another to form a local network of seat electronic devices.

### TECHNICAL FIELD

The present disclosure relates to a transportation vehicle such as an aircraft, and more particularly, to technology for providing a position of a transportation vehicle to display the position in the transportation vehicle.

### BACKGROUND

Transportation vehicles, for example, aircraft, trains, buses, recreation vehicle, boats and other similar vehicles use various computing devices for providing various functions, including entertainment, system control, content storage, and other functions. These computing devices include hardware (for example, servers, switches, network interface cards, storage adapters, storage devices and others) and software (for example, server applications, operating systems, firmware, management applications, application programming interface (APIs) and others).

Aircrafts today have individualized functional equipment dedicated to a passenger seat, which can be utilized by a passenger, such as adjustable seats, adjustable environmental controls, adjustable lighting, telephony systems, video and/or audio entertainment systems, crew communication systems, and the like. For example, many commercial airplanes have individualized video and audio entertainment systems, often referred to as “in-flight entertainment” or “IFE” systems.

Some seat devices at seats of a transportation vehicle may be capable of displaying the location of the transportation vehicle. For example, one of the most widely used feature on an IFE system of an aircraft is a flight map feature that provides location information of the aircraft with a map displayed in the background. Conventionally, a central server (e.g., head end server) within the transportation vehicle constantly sends and updates the location information of the aircraft to the seat devices so that the seat devices can display the location information. However, if the central server fails to operate properly, the seat devices may no longer be able to display accurate location information of the transportation vehicle Continuous efforts are being made to develop technologies that allows seat devices to display location information of a transportation vehicle, independently from a central server.

### BRIEF DESCRIPTION OF THE DRAWINGS

The various features of the present disclosure will now be described with reference to the drawings of the various aspects disclosed herein. In the drawings, the same components may have the same reference numerals. The illustrated aspects are intended to illustrate, but not to limit the present disclosure. The drawings include the following Figures:

FIG. 1A shows an example of an operating environment for implementing the various aspects of the present disclosure on an aircraft;

FIG. 1B shows an example of the operating environment on a non-aircraft transportation vehicle type, according to one aspect of the present disclosure;

FIG. 2 shows an example of a content distribution system, used according to one aspect of the present disclosure;

FIG. 3A shows an example of a system for providing a position of a transportation vehicle by a seat electronic device associated with at least one seat in the transportation vehicle, according to one aspect of the present disclosure;

FIG. 3B shows an example diagram showing seat boxes forming a local network, where the seat electronic device determining the position information is a seat box, according to an aspect of the present disclosure;

FIG. 3C is an example diagram showing seat devices forming a local network, where the seat electronic device determining the position information is a seat device, according to an aspect of the present disclosure;

FIG. 3D shows an example diagram illustrating a transportation vehicle receiving travel information from an external device, according to an aspect of the present disclosure;

FIG. 4A shows a process flow diagram for providing a position of a transportation vehicle by a seat electronic device associated with at least one seat in the transportation vehicle, according to an aspect of the present disclosure;

FIG. 4B shows a process flow diagram by the seat electronic device, continuing from FIG. 4A, according to an aspect of the present disclosure;

FIG. 5 shows a block diagram of a computing system, used according to one aspect of the present disclosure.

### DETAILED DESCRIPTION

In one aspect, innovative technology is disclosed for providing a position of a transportation vehicle to display the position in the transportation vehicle. A transportation vehicle may provide a feature to display a current position of the transportation vehicle on a display device of a seat device at a seat in the transportation vehicle or on a display device of a portable electronic device of a passenger of the transportation vehicle. Conventionally, the current position of the transportation vehicle is provided by a head end server of the transportation vehicle. However, in case of a failure associated with the head end server, the head end server may not be accessed to receive the current position of the transportation vehicle. Hence, according some aspects of the present disclosure, a seat electronic device, such as a seat box or a seat device, may determine position information of the transportation vehicle and provide the position information to a display device to display the position information, without constantly relying on the head end server. In an aspect, the position information may be based on information from a location estimation device coupled to the seat electronic device, an external device independent from the transportation vehicle, and/or from another seat electronic device. Hence, even if the head end server fails to provide the current position or is unavailable, the seat electronic device can still determine the position information on its own and provide the position information to display on a display device.

As a preliminary note, the terms “component”, “module”, “system”, and the like as used herein are intended to refer to a computer-related entity, either software-executing general-purpose processor, hardware, firmware or a combination thereof. For example, a component may be, but is not limited to being, a process running on a hardware processor, a hardware processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer/machine readable media including, but not limited to, an ASIC (application specific integrated circuit), CD (compact disc), DVD (digital video disk), ROM (read only memory), hard disk, EEPROM (electrically erasable programmable read only memory), solid state memory device or any other storage device, in accordance with the claimed subject matter.

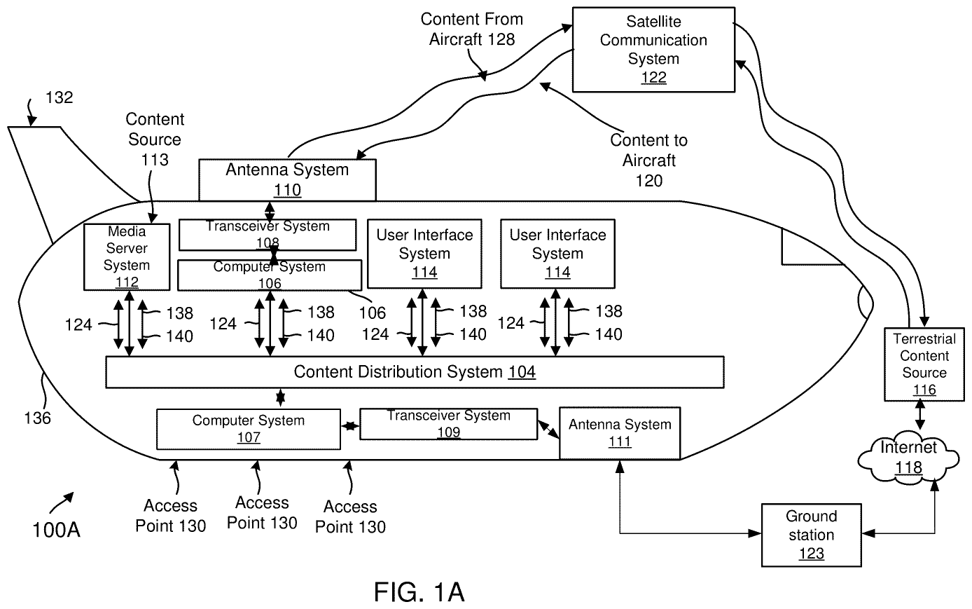

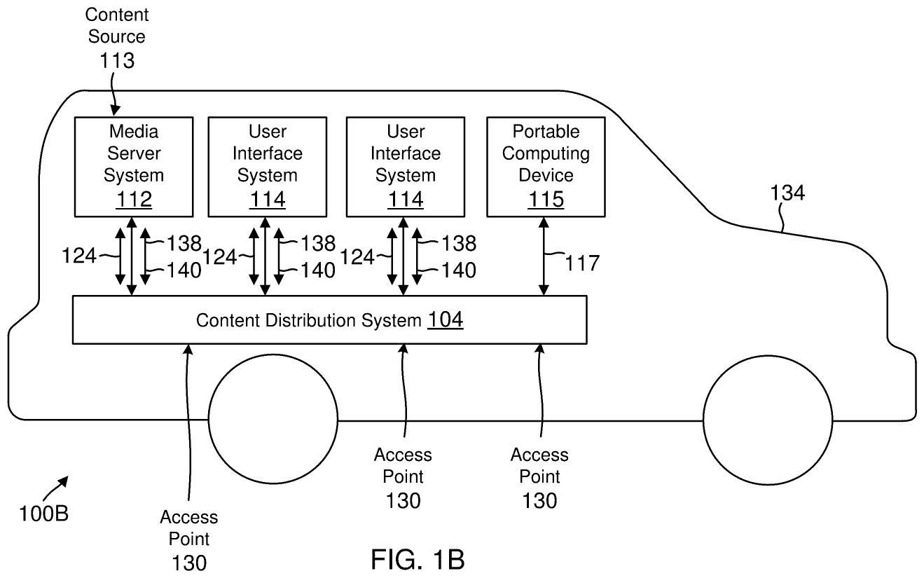

Vehicle Information System: FIG. 1A shows an example of a generic vehicle information system 100A (also referred to as system 100A) that can be configured for installation aboard an aircraft 132, according to one aspect of the present disclosure. When installed on an aircraft, system 100A can comprise an aircraft passenger IFE system, such as the Series 2000, 3000, eFX, eX2, eXW, eX3, NEXT, and/or any other in-flight entertainment system developed and provided by Panasonic Avionics Corporation (without derogation of any trademark rights of Panasonic Avionics Corporation) of Lake Forest, California, the assignee of this application.

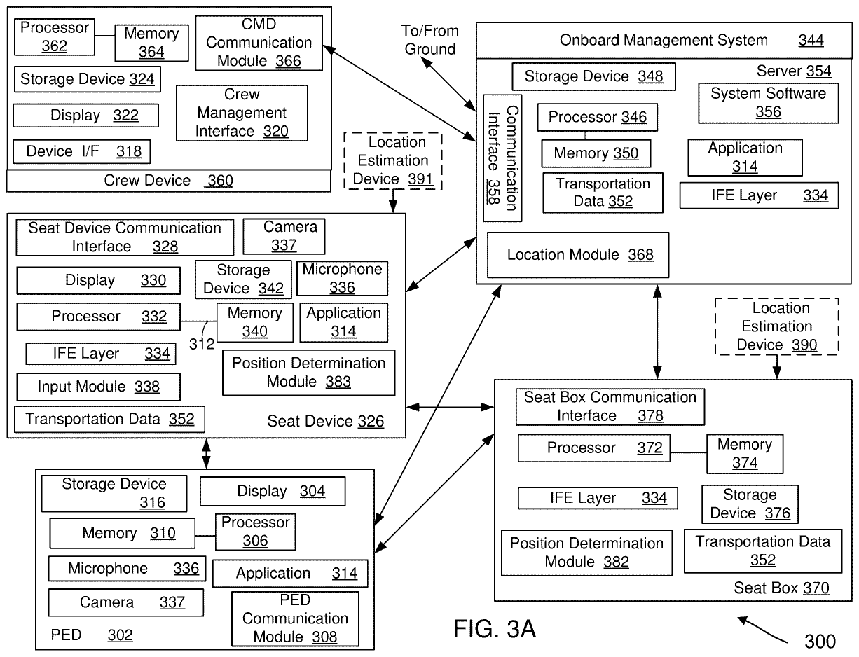

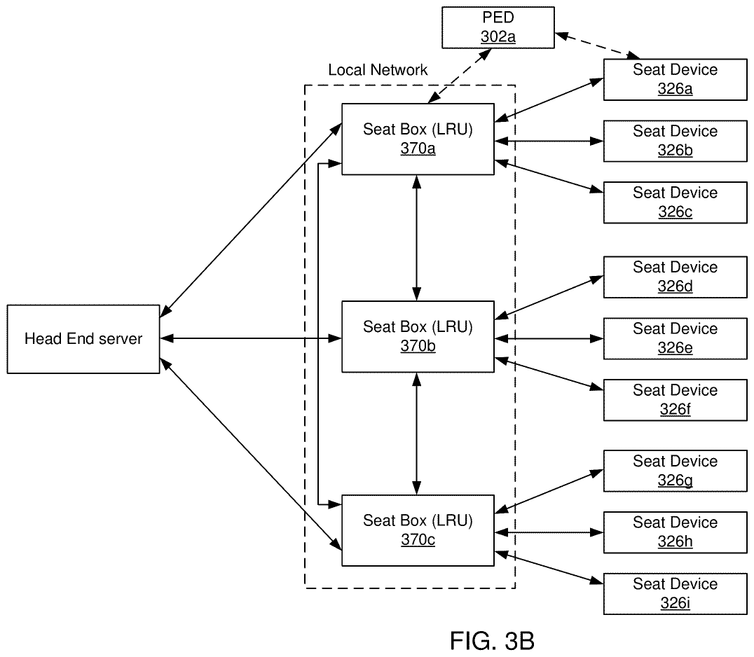

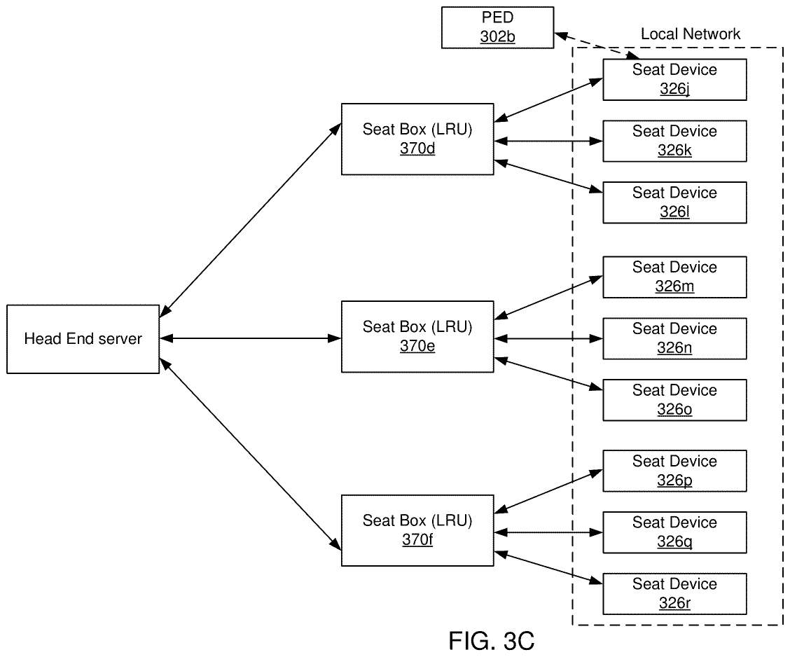

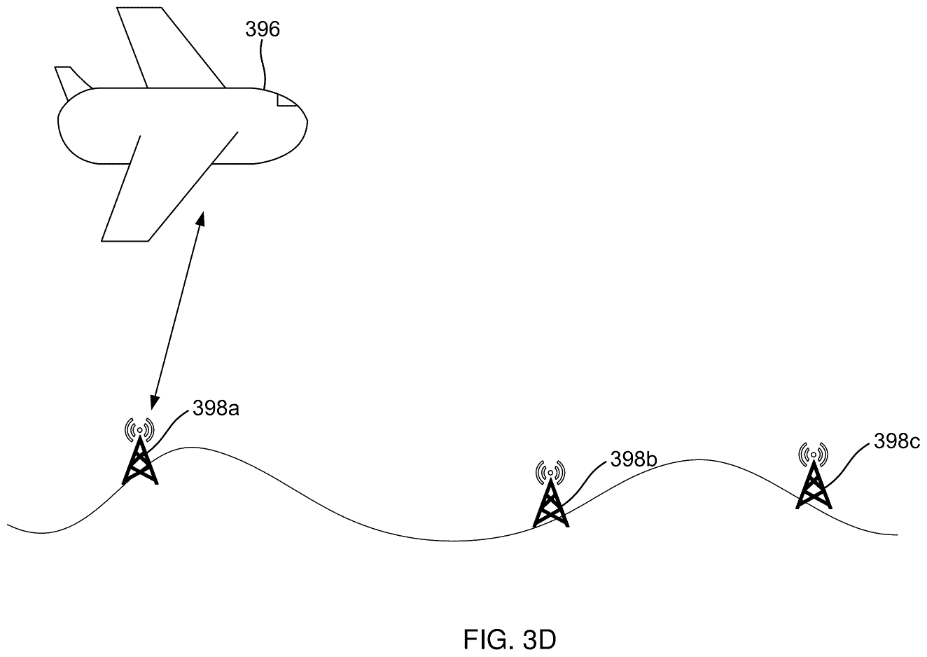

System 100A may include one or more content source 113 and one or more user (or passenger) interface systems (may also be referred to as a seat device/seatback device/IFE device 326 described below with respect to FIG. 3) 114 that communicate with a real-time content distribution system 104.

As an example, the content sources 113 may include one or more internal content sources, such as a media server system 112, that are installed aboard the aircraft 132, one or more remote (or terrestrial) content sources 116 that can be external from the aircraft 132, or a distributed content system. The media server system 112 can be provided as an information system controller for providing overall system control functions for system 100A and/or for storing viewing content 124, including pre-programmed viewing content and/or content 120 downloaded to the aircraft, as desired. The viewing content 124 can include television programming content, music content, podcast content, photograph album content, audiobook content, and/or movie content without limitation. The viewing content as shown and described herein is not exhaustive and are provided herein for purposes of illustration only and not for purposes of limitation.

The server system 112 can include, and/or communicate with, one or more conventional peripheral media storage systems (not shown), including optical media devices, such as a digital video disk (DVD) system or a compact disk (CD) system, and/or magnetic media systems, such as a solid state drive (SSD) system, or a hard disk drive (HDD) system, of any suitable kind, for storing preprogrammed content and/or downloaded content 120.

The viewing content 124 can comprise any conventional type of audio and/or video viewing content, such as stored (or time-delayed) viewing content and/or live (or real-time) viewing content. As desired, the viewing content 124 can include geographical information. Alternatively, and/or additionally, to entertainment content, such as live satellite television programming and/or live satellite radio programming and/or live wireless video/audio streaming, the viewing content likewise can include two-way communications, such as real-time access to the Internet 118 and/or telecommunications and/or a ground station 123 that communicates through an antenna 111 to a transceiver system 109, and a computer system 107 (similar to computer system 106). The functionality of computer system 107 is like computing system 106 for distributing content using the content distribution system 104 described herein. It is noteworthy that although two antenna systems 110/111 have been shown in FIG. 1A, the adaptive aspects disclosed herein may be implemented by fewer or more antenna systems.

Being configured to distribute and/or present the viewing content 124 provided by one or more selected content sources 113, system 100A can communicate with the content sources 113 in real time and in any conventional manner, including via wired and/or wireless communications. System 100A and the terrestrial content source 116, for example, can communicate directly and/or indirectly via an intermediate communication system, such as a satellite communication system 122 or the ground station 123.

System 100A can receive content 120 from a selected terrestrial content source 116 and/or transmit (upload) content 128, including navigation and other control instructions, to the terrestrial content source 116. In one aspect, content 120 includes media content that is stored persistently on the aircraft for passenger consumption. The media content for persistence storage is handled differently than live television content, as described below. As desired, terrestrial content source 116 can be configured to communicate with other terrestrial content sources (not shown). Terrestrial content source 116 is shown as providing access to the Internet 118. Although shown and described as comprising the satellite communication system 122 and the cellular base station 123 for purposes of illustration, the communication system can comprise any conventional type of wireless communication system, such as any wireless communication system and/or an Aircraft Ground Information System (AGIS) communication system.

To facilitate communications with the terrestrial content sources 116, system 100A may also include an antenna system 110 and a transceiver system 108 for receiving the viewing content from the remote (or terrestrial) content sources 116. The antenna system 110 preferably is disposed outside, such as an exterior surface of a fuselage 136 of the aircraft 132. The antenna system 110 can receive viewing content 124 from the terrestrial content source 116 and provide the received viewing content 124, as processed by the transceiver system (may also referred to as broadband controller) 108, to a computer system 106 of system 100A. The computer system 106 can provide the received viewing content 124 to the media (or content) server system 112 and/or directly to one or more of the user interfaces 114 including a PED, as desired. Although shown and described as being separate systems for purposes of illustration, the computer system 106 and the media server system 112 can be at least partially integrated.

The user interface system 114 may be computing terminals in communication with an access point 130. The user interface system 114 provides a display device to view content. The user interface system 114 includes a hardware interface to connect to an access point 130 that provides a wired and/or a wireless connection for the user interface system. In at least one embodiment, the user interface system 114 comprises a software application that a user downloads and installs on a PED to receive and view content via a wireless access point 130. While bandwidth limitation issues may occur in a wired system on a vehicle, such as an aircraft 132, in general the wired portion of the vehicle information 100A system is designed with enough bandwidth to support all users aboard the vehicle, i.e., passengers.

The user interface system 114 can include an input system (not shown) for permitting the user (or passenger) to communicate with system 100A, such as via an exchange of control signals 138. For example, the input system can permit the user to input one or more user instructions 140 for controlling the operation of system 100A. Illustrative user instructions 140 can include instructions for initiating communication with the content source 113, instructions for selecting viewing content 124 for presentation, and/or instructions for controlling the presentation of the selected viewing content 124. If a fee is required for accessing the viewing content 124 or for any other reason, payment information likewise can be entered via the input system. The input system can be provided in any conventional manner and typically includes a touch screen, application programming interface (API), one or more switches (or pushbuttons), such as a keyboard or a keypad, and/or a pointing device, such as a mouse, trackball, or stylus.

In one aspect, the user interface system 114 is provided on individual passenger seats of aircraft 132. The user interface system 114 can be adapted to different aircraft and seating arrangements and the adaptive aspects described herein are not limited to any specific seat arrangements or user interface types.

FIG. 1B shows an example of implementing the vehicle information system 100B (may be referred to as system 100B) on an automobile 134 that may include a bus, a recreational vehicle, a boat, and/or a train, or any other type of passenger vehicle without limitation. The various components of system 100B may be like the components of system 100A described above with respect to FIG. 1A and for brevity are not described again.

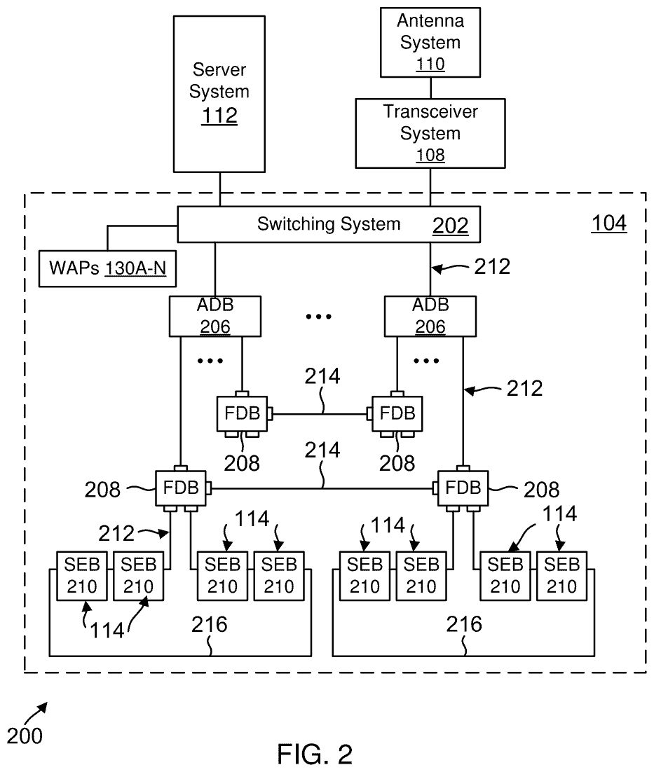

Content Distribution System: FIG. 2 illustrates an example of the content distribution system 104 for the vehicle information system 200 (similar to 100A/100B), according to one aspect of the present disclosure. The content distribution system 104 couples, and supports communication between the server system 112, and the plurality of user interface systems 114. The content distribution system 104, for example, can be provided as a conventional wired and/or wireless communication network, including a telephone network, a local area network (LAN), a wide area network (WAN), a campus area network (CAN), personal area network (PAN) and/or a wireless local area network (WLAN) of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

Preferably being configured to support high data transfer rates, the content distribution system 104 may comprise a high-speed Ethernet network, such as any type of Fast Ethernet (such as 100 Base-X and/or 100 Base-T) communication network and/or Gigabit (such as 1000 Base-X and/or 1000 Base-T) Ethernet communication network, with a typical data transfer rate of at least approximately one hundred megabits per second (100 Mbps) or any other transfer rate. To achieve high data transfer rates in a wireless communications environment, free-space optics (or laser) technology, millimeter wave (or microwave) technology, and/or Ultra-Wideband (UWB) technology can be utilized to support communications among the various system resources, as desired.

As illustrated in FIG. 2, the distribution system 104 can be provided as a plurality of area distribution boxes (ADBs) 206, a plurality of floor disconnect boxes (FDBs) 208, and a plurality of seat electronics boxes (SEBs) (and/or video seat electronics boxes (VSEBs) and/or premium seat electronics boxes (PSEBs)) (also referred to as seat boxes) 210 being configured to communicate in real time via a plurality of wired and/or wireless communication connections 212.

The distribution system 104 likewise can include a switching system 202 for providing an interface between the distribution system 104 and the server system 112. The switching system 202 can comprise a conventional switching system, such as an Ethernet switching system, and is configured to couple the server system 112 with the ADBs 206. Each of the ADBs 206 is coupled with, and communicates with, the switching system 202. In addition, the distribution system 104 includes one or more wireless access points (WAPs) (130A to 130N) connected in communication with the switch system 202 for wireless distribution of content to user interface systems 114 including PEDs.

Each of the ADBs 202, in turn, is coupled with, and communicates with, at least one FDB 208. Although the ADBs 206 and the associated FDBs 208 can be coupled in any conventional configuration, the associated FDBs 208 preferably are disposed in a star network topology about a central ADB 206 as illustrated in FIG. 2. Each FDB 208 is coupled with, and services, a plurality of daisy-chains of SEBs 210. The SEBs 210, in turn, are configured to communicate with the user interface systems 114. Each SEB 210 can support one or more of the user interface systems 114.

The switching systems 202, the ADBs 206, the FDBs 208, the SEBs (and/or VSEBs), and/or PSEBs) 210, the antenna system 110 (or 111), the transceiver system 108, the content source 113, the server system 112, and other system resources of the vehicle information system preferably are provided as line replaceable units (LRUs). The use of LRUs facilitate maintenance of the vehicle information system 200 because a defective LRU can simply be removed from the vehicle information system 200 and replaced with a new (or different) LRU. The defective LRU thereafter can be repaired for subsequent installation. Advantageously, the use of LRUs can promote flexibility in configuring the content distribution system 104 by permitting ready modification of the number, arrangement, and/or configuration of the system resources of the content distribution system 104. The content distribution system 104 likewise can be readily upgraded by replacing any obsolete LRUs with new LRUs.

Distribution system 104 can include at least one FDB internal port bypass connection 214 and/or at least one SEB loopback connection 216. Each FDB internal port bypass connection 214 is a communication connection 212 that permits FDBs 208 associated with different ADBs 206 to directly communicate. Each SEB loopback connection 216 is a communication connection 212 that directly couples the last SEB 210 in each daisy-chain of seat electronics boxes 210 for a selected FDB 208 as shown in FIG. 2. Each SEB loopback connection 216 therefore forms a loopback path among the daisy-chained seat electronics boxes 210 coupled with the relevant FDB 208.

It is noteworthy that the various aspects of the present disclosure may be implemented without using FDB 208. When FDB 208 is not used, ADB 206 communicates directly with SEB 210 and/or server system 112 may communicate directly with SEB 210 or the seats. The various aspects of the present disclosure are not limited to any specific network configuration.

System 300: FIG. 3A shows an example of a system 300 configured to operate within a transportation vehicle system such as an aircraft system, including an onboard management system 344 executing an IFE layer, according to one aspect of the present disclosure. In one aspect, system 300 includes the onboard management system 344 with a server 354, a seat device 326, a seat box 370 (similar to SEB 210), a PED 302, when authorized, and a crew device (may be referred to as “CMD”) 360, when authorized. In yet another aspect, system 300 includes the CMD 360, the seat device 326, and the seat box 370,, respectively. The seat box 370 and/or the seat device 326 may be provided as LRUs.

In one aspect, the onboard management system 344 includes server 354 (similar to the media server 112 and/or computer system 106/107 described above with respect to FIG. 1A/1B). The server 354 includes a processor 346 that has access to a memory 350 via a bus system/interconnect (similar to 312 on seat device 326). The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 346 may be, or may include, one or more programmable, hardware-based, general-purpose or special-purpose microprocessors, digital signal processors (DSPs), programmable controllers, application specific integrated circuits (ASICs), programmable logic devices (PLDs), or the like, or a combination of such devices.

Processor 346 has access to a storage device 348 that may be used to store data (for example, transportation data 352 and applications and program files, including system software 356, application 314, and others. In an aspect, the processor 346 may also have access to a location module 368 (may be referred to as module 368) for determining a location of the transportation vehicle, as described below in detail. As described below in detail, the server 354 may be connected to a positioning device such as a global positioning system (GPS) device, such that the location module 368 may use information from the positioning device to estimate a location of the transportation vehicle.

In one aspect, system software 356 is executed by processor 346 to control the overall operation of the server 354. Application 314 may be downloaded from server 354 by passengers using an authorized PED 302 paired with the seat device 326 and/or server 354 for accessing digital content.

In one aspect, the onboard management system 344 includes a display 347 to display information. The display 347 may also include a touch screen for receiving input commands. For example, the display 347 may be used to display maintenance information, such as maintenance indicators associated with seat devices, as described below. For example, a maintenance crew may be able to view the maintenance information on display 347 and perform any necessary tasks based on the maintenance information.

In one aspect, the onboard management system 344 may maintain transportation data 352 (may also be referred to as data 352), for example, a flight identifier, flight itinerary including a departure/origin location, layover locations, a destination location, departure time, arrival time and other information. Data 352 may also include passenger data that identifies each passenger for a flight, a seat assigned to a passenger, a language preference for the passenger, and any other information that can uniquely identify the passengers. Data 352 may be received from a ground system before flight departure. In an aspect, data 352 may be stored in the seat box 370 and/or seat device 326.

In one aspect, server 354 communicates with CMD 360, PED 302, seat box 370, and/or seat device 326 via the communication interface 358. The communication interface 358 may also be used to receive information from the ground, for example, data 352 and other information. The communication interface 358 includes one or more interfaces for a wired and/or wireless connection, as described above with respect to FIG. 1A/1B and 2.

In one aspect, seat device 326 includes a display device 330, a processor 332, a memory 340, a seat device communication interface (also referred to as communication interface) 328 and a local storage device 342 for storing content. In an example, the storage device 342 may store the transportation data 352, which may be received from the server 354 and/or the seat box 370. The seat device may optionally include a camera 337 and a microphone 336. The camera may be used to take pictures and videos and the microphone may be used for receiving voice input.

In one aspect, the seat device 326 receives user input/requests via an input module 338. The input module 338 may be configured to use a local touch screen included with display 330, a local virtual keyboard, an external mouse, external keyboard or any other input device.

In one aspect, processor 332 has access to memory 340 via an interconnect 312. Processor 332 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The bus system 312 is an abstraction that represents any one or more separate physical buses and/or point-to-point connections, connected by appropriate bridges, adapters and/or controllers. The bus system 312, therefore, may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

In one aspect, processor 332 executes an IFE layer 334 out of memory 340. The IFE layer 334 provides in-flight entertainment and other options for users. The IFE layer 334 provides audio/video content as well as controls for accessing the content.

In one aspect, the IFE layer 334 uses the seat device communication interface 328 to interface with the PED 302 and/or onboard management system 344. The communication interface 328 includes logic and circuitry for interfacing with the onboard management system 344 and/or PED 302. In one aspect, the communication interface 328 may use a wireless and/or wired connection for such communication.

In one aspect, the seat device 326 may also execute the application 314 that may be used by the passenger to view media content or various computing functions that are enabled by the seat device 326. Application 314 when executed by the seat device 326 may have different functionality compared to when application 314 is executed by the PED 302. In one example, application 314 may include features to display a position of the vehicle, e.g., on display 330 of the seat device 326.

The seat device 326 on the aircraft may be part of the user interface system 114 or interfaces with the user interface system 114 also described above with respect to FIG. 1A/1B. It is noteworthy that seat device 326 need not be mounted on the back of a seat and may be supported from other structures, such as a bulkhead, wall, arm of a seat, etc. The adaptive aspects of the present disclosure are not limited to any specific location or orientation of the seat device 326.

In one aspect, CMD 360 that may be a mobile phone, a notebook, a tablet, a laptop or any other similar device. CMD 360 may include a processor 362 that has access to a memory 364 via a bus system/interconnect (similar to 312) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 362 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

In one aspect, CMD 360 includes a display 322 to display information. Display 322 may also include a touch screen for receiving input commands. CMD 360 typically includes a microphone (not shown) for receiving voice input. CMD 360 may also include a camera (not shown) for taking pictures or making a video. The CMD 360 may also include a storage device 324 that may include any storage medium for storing data in a non-volatile manner, such as one or more magnetic or optical based disks, flash memory, or solid-state drive. The storage device 316 may be used to store a device interface 318, may also be referred to as a “crew management interface (CMI)” 318 that may be executed out of memory 364.

The CMI 318 enables the CMD 360 to interface with the onboard management system 344 via a CMD communication module 366. The CMD 360 may present one or more APIs to the onboard management system 344 to retrieve passenger/flight data. The non-limiting API format and syntax will depend on the protocols used by the CMD 360 and the onboard management system 344.

In one aspect, the CMD communication module 366 is also used to communicate with the seat device 326, when installed, and one or more PEDs 302. CMI 320 receives information regarding one or more seat attributes that do not meet take-off and/or landing conditions. CMI 320 notifies the seat device and/or paired PED 302 if a passenger needs to take action (e.g., move the passenger seat, tray table, window or any other action.

In one aspect, the CMD communication module 366 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the CMD communication module 366 for convenience, the communication module may have different interface, cards, logic and circuitry to comply with the different communication protocols/standards.

In one aspect, the PED 302 is securely paired with the seat device 326. The term “pair” means that PED 302 is associated and authenticated by the seat device 326 and/or server 354 to send and receive information.

As an example, the PED 302 may be a mobile phone, a notebook, a tablet, a laptop or any other computing device. PED 302 may include a processor 306 that has access to a memory 310 via a bus system/interconnect (similar to 312 on the seat device 326) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 306 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

PEDs 302 may also include a microphone 336 for receiving voice input from a passenger. The voice input can be converted into text by application 314 for processing. In another aspect, PED 302 also includes a camera 337 that may be used by a passenger to upload a video.

PED 302 includes a storage device 316 that may be or may include any storage medium for storing data in a non-volatile manner, such as one or more magnetic or optical based disks, flash memory, or solid-state drive. The storage device 316 may be used to store content displayed on display 304 of PED 302 when used by a passenger. In one aspect, display 304 may include a touch screen for receiving input commands.

The storage device 316 may also store the application 314 that is executed out of memory 310. Application 314 may be used to pair the PED 302 with the aircraft systems to receive content from device 115, as well as to communicate with CMD 360.

As an example, application 314 may be made available for download and installation via a public repository such as that maintained respectively under the trademark GOOGLE PLAY by Google, Inc. and/or the APP STORE maintained by Apple Inc. (without derogation to any third party trademark rights). In addition, application 314 may be provided for download by an airline carrier on a website or from the onboard management system 344. In one example, application 314 may include a vehicle position application to display a position of the vehicle.

In one aspect, PED 302 uses a PED communication module 308 to communicate with the seat device 326 and/or CMD 360, when installed. In one aspect, PED communication module 308 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the PED communication module 308 for convenience, the communication module may have different interface, cards, logic and circuitry to comply with the different communication protocols/standards.

In one aspect, the CMD communication module 366 is also used to communicate with the seat device 326, when installed, and/or the seat box 370. CMI 320 receives information regarding one or more seat attributes that do not meet take-off and/or landing conditions. CMI 320 notifies the seat device directly and/or via the seat box 370 if a passenger needs to take action (e.g., move the passenger seat, tray table, window or any other action.

In one aspect, the CMD communication module 366 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the CMD communication module 366 for convenience, the communication module may have different interface, cards, logic and circuitry to comply with the different communication protocols/standards.

The seat box 370 uses a seat box communication interface 378 to communicate with the seat device 326, the PED 302, and/or CMD 360. For example, data may be communicated from the CMD 360 to the seat box 370 via the seat box communication interface 378, and the data may be transmitted to the seat device 325 via the seat box communication interface 378. In one aspect, seat box communication interface 378 includes a communication interface for data communication with the onboard management system 344 and/or the seat device 326. It is noteworthy that the communication interface 378 may have different interface, cards, logic and circuitry to comply with the different communication protocols/standards.

In an example, the seat box 370 may include a processor 372 that has access to a memory 374 via a bus system/interconnect (similar to 312 on the seat device 326) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 306 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

In an example, the seat box 370 includes a storage device 376 that may be or may include any storage medium for storing data in a non-volatile manner, such as one or more magnetic or optical based disks, flash memory, or solid-state drive. In one aspect, the storage device 376 may store information or data received from the server 354. In an example, the storage device 376 may be used to store content to be displayed on display 330 of the seat device 326. In an example, the storage device 376 may store the transportation data 352, which may be received from the server 354.

In one aspect, the seat box 370 may include a position determination module 382 configured to determine position information including a current position of the transportation vehicle based on travel information associated with the transportation vehicle, as described below. Then, the position information may be transmitted to the seat device 326 to display the position information on the display device 330 and/or may be transmitted to the PED 302 to display the position information on the display device 304. The travel information may be received from a location estimation device 390 coupled to the seat box 370 and/or, an external device independent from the transportation vehicle, and/or another seat box, as described below. In this aspect, the position determination module 382 may be configured to continue to update the position information without relying on the server 354.

In one aspect, the seat device 326 may include a position determination module 383 configured to determine the position information based on the travel information, as described below. Then, the position information may be sent to the display device 330 to display the position information and/or may be transmitted to the PED 302 to display the position information on the display device 304. The travel information may be received from a location estimation device 391 coupled to the seat device 326 and/or, an external device independent from the transportation vehicle, and/or another seat box, as described below. In this aspect, the position determination module 383 may be configured to continue to update the position information without relying on the server 354.

In one aspect, the PED 302 is securely paired with the seat device 326. The term “pair” means that PED 302 is associated and authenticated by the seat device 326 and/or server 354 to send and receive information.

As an example, the PED 302 may be a mobile phone, a notebook, a tablet, a laptop or any other computing device. PED 302 may include a processor 306 that has access to a memory 310 via a bus system/interconnect (similar to 312 on the seat device 326) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 306 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

PEDs 302 may also include a microphone 336 for receiving voice input from a passenger. The voice input can be converted into text by application 314 for processing. In another aspect, PED 302 also includes a camera 337 that may be used by a passenger to upload a video.

PED 302 includes a storage device 316 that may be or may include any storage medium for storing data in a non-volatile manner, such as one or more magnetic or optical based disks, flash memory, or solid-state drive. The storage device 316 may be used to store content displayed on display 304 of PED 302 when used by a passenger. In one aspect, display 304 may include a touch screen for receiving input commands.

The storage device 316 may also store the application 314 that is executed out of memory 310. Application 314 may be used to pair the PED 302 with the aircraft systems to receive content from device 115, as well as to communicate with CMD 360.

As an example, application 314 may be made available for download and installation via a public repository such as that maintained respectively under the trademark GOOGLE PLAY by Google, Inc. and/or the APP STORE maintained by Apple Inc. (without derogation to any third party trademark rights). In addition, application 314 may be provided for download by an airline carrier on a website or from the onboard management system 344.

In one aspect, PED 302 uses a PED communication module 308 to communicate with the seat device 326, the seat box 370, and/or CMD 360, when installed. In one aspect, PED communication module 308 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the PED communication module 308 for convenience, the communication module may have different interface, cards, logic and circuitry to comply with the different communication protocols/standards.

A transportation vehicle such as an aircraft may include an entertainment system that can display a current position of the transportation vehicle. For example, an aircraft may include an IFE system that can display a current position of the aircraft on a seat device or on a PED. One example of displaying the current position of the aircraft is a flight map feature on the seat device, which displays an icon representative of the aircraft's position over a map. The flight map feature may also display travel information such as a direction of the aircraft's travel, a time elapsed since a departure, and a time remaining until a destination. A head end server such as the server 354 generally estimates the current position of the transportation vehicle (e.g., via the location module 368), and forwards the estimated position of the transportation vehicle to a seat device and/or a PED, either directly or via the seat box, such that the estimated position may be displayed at the seat device and/or at the PED. In an example, the head end server may estimate the current position by retrieving location information from a GPS device connected to the head end server.

If the head end server or a connection to the head end server fails, the position estimated by the head end server will no longer be available to display at a seat device or at a PED. For example, the head end server may fail to work properly when at least one of a power supply or a processor or a storage device or a memory for the head end server fails. Some transportation vehicles may have multiple head end servers, and thus when a head end server becomes unavailable or inaccessible, another head end server may estimate the current position and provide the estimated position to display the estimated position. For example, when there is a failure associated with the head end server, a second head end server can estimated the position and provide the position to display it within an acceptable timeframe, such that a passenger may not realizes the failure associated with the head end server or may only be slightly inconvenienced until the second head end server completely takes over the operation to estimate and provide the position to display at the seat device and/or the PED. However, many transportation vehicles have only a single head end server, and thus a failure associated with the head end server may result in failure to provide the estimated position of the transportation vehicle to display at a seat device and/or at a PED. Hence, in this case, with the failure associated with the single head end serve, a passenger may not be able to view the current position of the transportation vehicle. Therefore, an approach to provide the current position of the transportation vehicle to a passenger independently from a head end server is desired.

According to some aspects of the disclosure, a position of a transportation vehicle is provided by a seat electronic device associated with at least one seat in the transportation vehicle, without constantly relying on the head end server, where the seat electronic device is a part of a group of seat electronic devices that connected to one another to form the local network. The seat electronic device first receives travel information associated with the transportation vehicle, where the travel information is received from at least one of a location estimation device coupled to the seat electronic device, an external device independent from the transportation vehicle, or at least one second seat electronic device of the group of seat electronic devices. The seat electronic device then determines position information including a current position of the transportation vehicle based on the travel information, and transmits the position information of the transportation vehicle to a display device to display information on the display device based on the position information. As such, the seat electronic device may be able to locally determine and provide the position information to display at a display device viewed by a passenger, without relying on a head end server.

In one aspect, the seat electronic device and the group of seat electronic devices may be a seat box and a group of seat boxes, respectively. In this aspect, the seat box (e.g., seat box 370) receives the travel information and determines the position information based on the travel information (e.g., using the position determination module 382). Further, the seat box (e.g., seat box 370) transmits (e.g., using the position determination module 382) the position information to a display device of a seat device (e.g., seat device 326) or a PED (e.g., PED 302) to display the information on the display device based on the position information. As such, the position information may be received and provided to the display device 330 via the seat device communication interface 328 or to the display device 304 via the PED communication module 308. In an aspect, the travel information may be received using the position determination module 382 via the seat box communication interface 378. In an aspect, the position information may be transmitted using the position determination module 382 via the seat box communication interface 378.

FIG. 3B shows an example diagram showing seat boxes forming a local network, where the seat electronic device determining the position information is a seat box, according to an aspect of the present disclosure. In the example shown in FIG. 3B, a head end server may be communicatively connected to a group of seat boxes including seat boxes 370a, 370b, and 370c. The head end server may be the server 354 of FIG. 3A, and each of the seat boxes 370a, 370b, and 370c may have similar features to the seat box 370 of FIG. 3A. The seat boxes 370a, 370b, and 370c are connected to one another to form a local network of seat boxes, where the seat boxes 370a, 370b, and 370c can communicate with one another. Although FIG. 3B shows the head end server connected to three seat boxes 370a, 370b, and 370c, the number of seat boxes connected to the head end server is not limited to three. In another example, the number of seat boxes connected to the head end server may not be three. Further, in the example shown in FIG. 3B, the seat box 370a is connected to seat devices 326a, 326b, and 326c, the seat box 370b is connected to seat devices 326d, 326e, and 326f, and the seat box 370c is connected to seat devices 326g, 326h, and 326i. Although FIG. 3B shows three seat devices connected to one seat box, the number of seat devices connected to one seat box may vary. Each of the seat devices 326a-326i may include the similar features to the seat device 326 of FIG. 3A.

In the example shown in FIG. 3B, each seat box is capable of receiving the travel information, determining the position information of the transportation vehicle, and transmitting the position information. For example, the seat box 370a receives the travel information and determines the position information of the transportation vehicle based on the travel information. Further, the seat box 370a transmits the position information to seat devices 326a-326c to display a vehicle position based on the position information on display devices of the seat devices 326a-326c. Additionally, in the example shown in FIG. 3B, the seat box 370a and/or the seat device 326a may transmit the position information to the PED 302a such that the vehicle position may be displayed on a display device of the PED 302a. The PED 302a may include similar features to the PED 302 of FIG. 3A. As such, the seat box 370a may determine and provide the position information to display at the seat device 326a and/or the PED 302a, without relying on the head end server. Therefore, even if the head end server becomes unavailable, the seat box 370a may still be able to provide the position information to display. It is noted that seat boxes 370b and 370c may also perform similar features to the features performed by the seat box 370a as described above.

In another aspect, the seat electronic device and the group of seat electronic devices may be a seat device and a group of seat devices, respectively. In this aspect, the seat device (e.g., seat device 326) receives the travel information and determines the position information based on the travel information (e.g., using the position determination module 383). Further, in this aspect, the seat device (e.g., seat device 326) transmits the position information to a display device of the seat device or a PED (e.g., PED 302) to display the information on the display device based on the position information. For example, the position information may be provided to the display device 330 or may be received at the PED communication module 308 to provide to the display device 304 via the PED communication module 308. In an aspect, the travel information may be received using the position determination module 383 via the seat device communication interface 328. In an aspect, the position information may be transmitted using the position determination module 383 to the display device 330.

FIG. 3C is an example diagram showing seat devices forming a local network, where the seat electronic device determining the position information is a seat device, according to an aspect of the present disclosure. In the example shown in FIG. 3C, a head end server may be communicatively connected to a group of seat boxes including seat boxes 370d, 370e, and 370f. The head end server may be the server 354 of FIG. 3A, and each of the seat boxes 370d, 370e, and 370f may have similar features to the seat box 370 of FIG. 3A. Although FIG. 3C shows the head end server connected to three seat boxes 370d, 370e, and 370f, the number of seat boxes connected to the head end server is not limited to three. In another example, the number of seat boxes connected to the head end server may not be three. Further, in the example shown in FIG. 3C, the seat box 370d is connected to seat devices 326j, 326k, and 3261, the seat box 370e is connected to seat devices 326m, 326n, and 3260, and the seat box 370f is connected to seat devices 326p, 326q, and 326r. Although FIG. 3C shows three seat devices connected to one seat box, the number of seat devices connected to one seat box may vary. Each of the seat devices 326j-326r may include the similar features to the seat device 326 of FIG. 3A. The seat devices 326j-326r are connected to one another to form a local network of seat devices, where the seat devices 326j-326r can communicate with one another. In some aspects, the seat boxes 370d, 370e, and 370f may also be connected to one another such that the seat boxes 370d, 370e, and 370f can communicate with one another.

In the example shown in FIG. 3C, each seat device is capable of receiving the travel information, determining the position information of the transportation vehicle, and transmitting the position information. For example, the seat device 326j receives the travel information and determines the position information of the transportation vehicle based on the travel information. Further, the seat device 326j transmits the position information to a display device of the seat device 326j to display a vehicle position based on the position information on the display device of the seat device 326j. In an aspect, the seat device 326 may transmit the position information to one or more of the seat devices 326j-326r, to display the vehicle position based on the position information on display device(s) of the one or more of the seat devices 326j-326r. Additionally, in the example shown in FIG. 3B, the seat device 326j may transmit the position information to the PED 302b such that the vehicle position may be displayed on a display device of the PED 302b. The PED 302b may include similar features to the PED 302 of FIG. 3A. As such, the seat device 326j may determine and provide the position information to display at the seat device 326j and/or the PED 302b, without relying on the head end server. Therefore, even if the head end server becomes unavailable, the seat device 326j may still be able to provide the position information to display.

As discussed above, a head end server such as the server 354 in the transportation vehicle may be configured to estimate the position of the transportation vehicle and forward the estimated position of the transportation vehicle to a seat device and/or a PED, either directly or via the seat box, such that the estimated position may be displayed at the seat device and/or at the PED. For example, the head end server may be connected to a GPS device, such that the head end server may determine the position of the transportation vehicle based on a GPS device. However, if the head end server or a connection to the head end server fails, the head end server cannot be used estimate the position of the transportation vehicle and thus the seat electronic device may be used instead to determine the position information.

Hence, in an aspect, the seat electronic device detects whether there is a failure associated with a head end server coupled to a positioning device in the transportation vehicle (e.g., using the position determination module 382 or 383). Upon detection of the failure, the seat electronic device can start determining and providing the position information to display on its own, without relying on the head end server. In this aspect, when the seat electronic device detects a failure associated with the head end server, the seat electronic device determines the position information (e.g., using the position determination module 382 or 383) based on the travel information received from the at least one of the location estimation device coupled to the seat electronic device, the external device, or another seat electronic device, and transmits the position information to the display device. As such, when the failure associated with the head end server is detected, the seat electronic device stops relying on the head end server and determines the position information itself to continue perform the features of providing a current position of the transportation vehicle to the display device even after the failure associated with the head end server. Here, the head end server is a centralized server connected to the group of the seat electronic devices and is configured to communicate a position of the transportation vehicle from the positioning device to the seat electronic devices, such that the seat electronic devices may provide the position received from the head end server to display devices to display the position. For example, the seat electronic device may determine that there is the failure associated with the head end server, if the seat electronic device cannot communicate with the head end server (e.g., due to an error at the head end server) and/or cannot receive the position of the transportation vehicle from the head end server (e.g., due to a communication error with the head end server).

In an aspect, the seat electronic device may rely on the head end server to display the position of the transportation device when there is no failure associated with the head end server. On the other hand, when any failure associated with the head end server is detected, the seat electronic device may stop relying on the head end server to display the current position and instead rely on the travel information received from at least one of the location estimation device coupled to the seat electronic device, the external device, or at least one second seat electronic device of the group of the seat electronic devices. As such, even in the event of the head end server failing to provide the position of the transportation vehicle, a passenger may be able to view the position of the transportation vehicle on the display device without interruptions, with the seat electronic device providing the position information. Hence, in this aspect, prior to detecting the failure associated with the head end server, the seat electronic device may receive central position information from the head end server, the central position information indicating a position of the transportation vehicle, and then may transmit the central position information to the display device to display the central position information on the display device (e.g., using the position determination module 382 or 383). In this aspect, after detecting the failure associated with the head end server, the seat electronic device may determine the position information based on the travel information in response to detecting the failure associated with the head end server, and then may transmit the position information the display device to display the position information (e.g., using the position determination module 382 or 383).

In one example, referring back to FIG. 3B, the head end server may be coupled to a positioning device and thus may be capable of providing central position information indicating a position of the transportation vehicle to the seat box 370a, so that the seat box 370a may relay the central position information to the seat device 326a and/or the PED 302a to display the central position information as the current position of the transportation vehicle. When there is no failure associated with the head end server and thus the seat box 370a is able to receive the position of the transportation vehicle from the head end server, the seat box 370a provides the central position information to the seat device 326a and/or the PED 302a to display the central position information as the current position of the transportation vehicle. If the seat box 370a detects a failure associated with the head end server, the seat box 370a at this point starts determining position information on its own, such that the seat box 370a may provide the position information to the seat device 326a and/or the PED 302a to display the position information determined by the seat box 370a as the current position, without relying on the head end server. As such, even in the event of the failure associated with the head end server, the seat device 326a and/or the PED 302a may be able to continue to display the current position of the transportation vehicle without interruptions.

In another example, referring back to FIG. 3C, the head end server may be coupled to a positioning device and thus may be capable of providing central position information indicating a position of the transportation vehicle to the seat box 370d, so that the seat box 370d may relay the central position information to the seat device 326j and/or the PED 302b to display the central position information as the current position of the transportation vehicle. If the seat device 326j detects a failure associated with the head end server, the seat device 326j at this point starts determining position information on its own, such that the seat device 326j may provide the position information to the display device of the seat device 326j and/or to the display device of the PED 302b to display the position information, without relying on the head end server. As such, even in the event of the failure associated with the head end server, the seat device 326j and/or the PED 302b may be able to continue to display the current position of the transportation vehicle without interruptions.

Various approaches may be available for the seat electronic device to determine the position information of the transportation vehicle on its own. According to one approach, in an aspect where the travel information may be received from the location estimation device coupled to the seat electronic device, the location estimation device may be a GPS tracking device coupled to the seat electronic device in the transportation vehicle. In this aspect, the GPS tracking device is configured to measure a position of the transportation vehicle and to communicate the travel information indicating the position of the transportation vehicle to the seat electronic device. In one example, referring back to FIG. 3B, a GPS tracking device (e.g., location estimation device 390) may be coupled to the seat box 370a, such that the seat box 370a can determine the position information based on the travel information received from the GPS tracking device, without relying on the head end server. In this example, the seat boxes 370b and 370c may be coupled to their GPS tracking devices and/or may receive the travel information from the seat box 370a after the seat box 370a receives the travel information from its GPS tracking device. In another example, referring back to FIG. 3C, a GPS tracking device (e.g., location estimation device 390) may be coupled to the seat box 370d or a GPS tracking device (e.g., location estimation device 391) the seat device 326j, such that the seat device 326j can determine the position information based on the travel information received from the GPS tracking device, without relying on the head end server. In this example, the seat devices 326k-326r may be coupled to their GPS tracking devices respectively and/or may receive the travel information from the seat device 326j after the seat device 326j receives the travel information from its GPS tracking device.

In one example, referring back to FIG. 3B, the head end server may at first provide the central position information via the seat box 370a to display at the seat device 326a and/or the PED 302a as the current position, as discussed above. Then, if the failure associated with the head end server is detected, the seat box 370a determines the position information based on the travel information received from the GPS tracking device coupled to the seat box 370a and provides this position information to display at the seat device 326a and/or the PED 302a as the current position. In another example, referring back to FIG. 3C, the head end server may at first provide the central position information via the seat box 370d to display at the seat device 326j and/or the PED 302b as the current position, as discussed above. Then, if the failure associated with the head end server is detected, the seat device 326j determines the position information based on the travel information received from the GPS tracking device coupled to the seat device 326j and provides this position information to the display device of the seat device 326j and/or the display device of the PED 302b as the current position.

In an aspect where the seat electronic device receives the travel information from at least one second seat electronic device of the group of seat electronic devices, each of the at least one second seat electronic device may be coupled to a respective GPS tracking device and may be configured to receive the travel information from the respective GPS tracking device to relay the travel information to the seat electronic device. Hence, for example, if the seat electronic device is not be directly coupled to a GPS tracking device or if there is an error in receiving information from a GPS tracking device coupled to the seat electronic device, the seat electronic device may rely on another seat electronic device coupled to a GPS tracking device to receive the travel information. In one example, referring back to FIG. 3B, a GPS tracking device may be coupled to the seat box 370b, such that the seat box 370b may receive the travel information from the GPS tracking device and relay the travel information to the seat box 370a (and the seat box 370c). Then, the seat box 370a may be able to determine the position information of the transportation vehicle based on this travel information received from the seat box 370b, and then provide the position information to the display device of seat device 326a and/or the display device of the PED 302a. In another example, referring back to FIG. 3C, a GPS tracking device may be coupled to the seat device 326k, such that the seat device 326k may receive the travel information from the GPS tracking device and relay the travel information to the seat device 326j (and other seat devices). Then, the seat device 326j may be able to determine the position information of the transportation vehicle based on this travel information received from the seat device 326k.

If multiple seat electronic devices are coupled to their own respective GPS tracking devices and thus can receive position values from their own respective GPS tracking devices, these position values may be considered to determine the position information of the tracking device to display. It may be beneficial to display the same position information at multiple seat devices and/or at multiple PEDs, for consistency. For example, a median or an average of the position values from the GPS tracking devices may be used as the position information to display at the multiple seat devices and/or at multiple PEDs. Hence, in an aspect, the seat electronic device receiving the travel information may receive the travel information including position values associated with a position of the transportation vehicle from the multiple seat electronic devices, respectively, where the seat electronic devices are coupled to their respective GPS tracking devices to receive the multiple position values respectively from their respective GPS tracking devices. In this aspect, the seat electronic device may determine the position information by selecting a median position value of the multiple position values (or an average of the multiple position values) to determine the position information. In some aspects, the seat electronic device may forward the position information to other seat electronic devices in the same local network, so that the other seat electronic devices can also transmit the same position information to display.

In one example, referring back to FIG. 3B, the seat boxes 370a, 370b, 370c may be coupled to their own respective GPS tracking devices and thus may be configured to receive their own position values from their own respective GPS tracking devices. The seat box 370b and the seat box 370c may send their own position values from their own respective GPS tracking devices to the seat box 370a, such that the seat box 370a may receive the position values from the seat box 370b and the seat box 370c as well as the position value from the GPS tracking device coupled to the seat box 370a, and then determine the position information by selecting a median position value of these position values as the position information. Then, the seat box 370a may transmit the position information including the median position value to the seat box 370b and the seat box 370c, such that the seat boxes 370a-370c may transmit the same position information to the seat devices 326a-326i to display at their display devices and/or to any PED(s) connected to any of the seat boxes 370a-370b.

In another example, referring back to FIG. 3C, the seat devices 326j-326r may be coupled to their own respective GPS tracking devices and thus may be configured to receive their own position values from their own respective GPS tracking devices. The seat device 326k-326r may send their own position values from their own respective GPS tracking devices to the seat device 326j, such that the seat device 326j may receive the position values from the seat devices 326k-326r as well as the position value from the GPS tracking device coupled to the seat device 326j, and then determine the position information by selecting a median position value of these position values as the position information. Then, the seat device 326j may transmit the position information including the median position value to the seat devices 326k-326r, such that the seat devices 326j-326r may provide the same position information (e.g., with the median position value) to display devices of seat devices 326j-326r and/or any PED(s) connected to any of the seat devices 326j-326r.

In some cases, the seat electronic device may not be able to receive the travel information from the location estimation device due to errors associated with the location estimation device and/or a connection to the location estimation device. When such an error occurs, the seat electronic device may receive the travel information from another source different from the location estimation device. Hence, in an aspect, the seat electronic device may detect (e.g., using the position determination module 382 or 383) whether an error in communication between the seat electronic device and the location estimation device exists.

In this aspect, when the seat electronic device detects an error in communication between the seat electronic device and the location estimation device, the seat electronic device may receive the travel information (e.g., using the position determination module 382 or 383) by receiving the travel information from the external device and/or the at least one second seat electronic device.

According to another approach, the seat electronic device may rely on the external device existing outside of the transportation vehicle, where the external device exists independently from the transportation vehicle, to determine the position information of the transportation vehicle. In an aspect, the external device exists outside of the transportation vehicle and separate from the transportation vehicle, where the seat electronic device may be configured to communicate with the external device via wireless communication.

In one example, referring to FIG. 3B, the seat box 370a may be configured to communicate with the external device using a wireless modem (e.g., via seat box communication interface 378) of the seat box 370a. In an example, the seat box 370a may share the information received from the external device with seat boxes 370b and 370c. In another example, referring to FIG. 3C, the seat device 326 may be configured to communicate with the external device using a wireless modem (e.g., via seat device communication interface 328) of the seat device 326j and/or a wireless modem (e.g., via seat box communication interface 378) of the seat box 370d. In an example, the seat device 326j may share the information received from the external device with seat devices 326k-326r.

To enable the external device to identify which vehicle is requesting the travel information, the transportation vehicle may transmit a vehicle identifier to the external device. In an aspect, the seat electronic device may transmit a vehicle identifier identifying the transportation vehicle to the external device via wireless communication (e.g., using the position determination module 382 or 383 via the communication interface 378 or 328). Then, the external device may identify the travel information associated with the transportation vehicle based on the vehicle identifier and transmit the travel information to the transportation vehicle, via wireless communication. As such, the seat electronic device may receive the travel information from the externa device based on the vehicle identifier. For example, the seat electronic device may be connected to a wireless modem to perform wireless communication with the external device. In another aspect, the seat electronic device may receive the travel information from a different seat electronic device that has received the travel information from the external device (e.g., based on the vehicle identifier transmitted by the different seat electronic device to the external device). For example, the vehicle identifier may be a vehicle number (e.g., flight number) or an aircraft tail number.

In an aspect, the travel information received via the external device (or a different seat electronic device) may include at least one of a departure location of the transportation vehicle, a destination location of the transportation vehicle, or a travel route of the transportation vehicle. For example, the seat electronic device may receive this travel information from the external device and/or from a different seat electronic device in the local network of the seat electronic devices, where the different seat electronic device has received this travel information from the external device. The departure location, the destination location, and the travel route may be known data even prior to the departure. Hence, for example, the seat electronic device may receive the travel information including at least one of the departure location, the destination location, or the travel route, either directly from the external device on the ground (e.g., via wireless communication using a modem connected to the seat electronic device) and/or via the head end server that has retrieved this travel information from the external device.

In an aspect, the wireless communication may be provided via a wireless communication modem connected to the seat electronic device. Here, the wireless communication modem may be configured to establish a wireless connection with at least one wireless base station out of multiple wireless base stations on the ground outside of the transportation vehicle.

According to one aspect, the external device may have access to a service or a feature that tracks a current location of a transportation vehicle, and thus the seat electronic device may wirelessly receive the travel information with the current location information from the external device to determine the position information. For example, an aircraft may be able to access automatic dependent surveillance broadcast (ADSB) data from the external device on the ground, where the aircraft regularly broadcasts the ADSB data to a device on the ground wirelessly, e.g., via a radio protocol or via satellite connections. The ADSB data may be communicated with an aircraft identifier (e.g., aircraft tail number), an altitude, a location coordinate, and/or a departure location and a destination location of the aircraft. A seat electronic device in an aircraft may not have direct access to the ADSB data within the aircraft, especially if there is a failure to access the head end server, and thus may receive the travel information with the current location of the aircraft from an external device on the ground via wireless communication. In one example, the seat electronic device in the aircraft may wirelessly access a website or a service that provides the location of the aircraft, such as https://www.flightaware.com/. In this example, the seat electronic device may wirelessly transmit an aircraft identifier of the aircraft to a device on the ground to receive the travel information with the current location of the aircraft using this web service.

According to another aspect, the position information of the transportation vehicle may be estimated based on data already previously known. As discussed above, the travel information received via at least one of the external device or the at least one second seat electronic device may include at least one of a departure location of the transportation vehicle, a destination location of the transportation vehicle, or a travel route of the transportation vehicle. For example, the seat electronic device may receive this travel information from the external device and/or from a different seat electronic device in the local network of the seat electronic devices, where the different seat electronic device has received this travel information from the external device. The departure location, the destination location, and the travel route may be known data even prior to the departure. Hence, for example, the seat electronic device may receive the travel information including at least one of the departure location, the destination location, or the travel route either directly from the external device on the ground and/or via the head end server that has retrieved this travel information from the external device.

In this aspect where the travel information includes at least one of the departure location, the destination location, and the travel route, the seat electronic device may estimate a position of the transportation vehicle based on this travel information. In this aspect, the seat electronic device may determine the position information by estimating a position of the transportation vehicle based on at least one of a last-known position of the transportation vehicle, the departure location, the destination location, the travel route, an elapsed time since a departure from the departure location, and a remaining time to the destination location, where the position information is based on the estimated position. For example, assuming that the transportation vehicle mostly stays on the travel route and does not deviate substantially from the travel route, the position of the transportation vehicle may be estimated based on the departure location, the destination location, the travel route, and further based on the elapsed time since the departure and/or the remaining time to the destination location. For example, if an aircraft mostly stays on the travel route and travels based on an expected schedule to arrive at the destination location at an expected time, the position may be estimated based on the departure location, the destination location, the travel route, and further based on the elapsed time since the departure and/or the remaining time to the destination location. In one example, if the departure location is New York City and the destination location is Los Angeles, the seat electronic device may be able to estimate that the position of the aircraft to be an expected location on the aircraft's travel route from New York City to Los Angeles at the elapsed time since the departure or for the remaining time to the destination location.

As discussed above, the head end server may at first provide the central position information as the current position to display, and then the seat electronic device may determine and provide the position information to display when a failure associated with the head end server is detected. In this aspect, the last-known position of the transportation vehicle may be the central position information provided by the head end server immediately prior to the detection of the failure associated with the head end server. For example, when the failure associated with the head end server is detected, the seat electronic device may estimate the position of the transportation vehicle based on at least one of the last-known position of the transportation vehicle, the departure location, the destination location, the travel route, the elapsed time since a departure from the departure location, and the remaining time to the destination location, and provide the estimated position to display as the current position.

According to another aspect, when receiving the travel information, the seat electronic device may receive the travel information including a location of the at least one wireless base station having the wireless connection established with the wireless communication modem connected to the seat electronic device. In this aspect, the seat electronic device may determine the position information by determining the position information based on the location of the at least one wireless base station. For example, numerous wireless base stations are located at different locations on the ground, to cover a large area for wireless communication. The seat electronic device of the transportation vehicle may wirelessly connect to a base station (e.g., a cellular tower or a radio tower) that is closest to the modem in the transportation vehicle. As the transportation vehicle moves, the closest base station to the modem may change and thus the modem may establish a wireless connection with a different base station depending on the location. Hence, by determining a position of the wireless base station connected to the seat electronic device, the seat electronic device may determine the position information of the transportation vehicle. The position information determined based on the location of the wireless base station connected to the seat electronic device may not be as accurate as the position information determined based on a GPS tracking device, especially if there is a large distance between wireless base stations. However, for a fast moving vehicle, the accuracy provided by the position information based on the location of the wireless base station may be sufficient to a passenger viewing an approximate location of the transportation vehicle based on the position information.

FIG. 3D shows an example diagram illustrating a transportation vehicle receiving travel information from an external device, according to an aspect of the present disclosure. In the example shown in FIG. 3D, the transportation vehicle is an aircraft 396 flying over a terrain having multiple base stations such as a first base station 398a, a second base station 398b, and a third base station 398c. In FIG. 3D, because the first base station 398a is closest to the aircraft 396, the modem connected to the seat electronic device has established a wireless communication with the first base station 398a. Then, in an aspect, the seat electronic device may receive the location of the first base station 398a from the first base station 398a via the modem and then estimate the position information of the transportation vehicle based on the location of the first base station 398a. As the aircraft 396 flies to the right closer to the second base station 398b and away from the first base station 398a, the modem connected to the seat electronic device may lose the wireless communication with the first base station 398a and may establish a new wireless connection with the second base station 398b. In this case, the seat electronic device may receive the location of the second base station 398b from the second base station 398b and estimate the position information of the transportation vehicle based on the location of the second base station 398b.

In another aspect, the seat electronic device may access a service or a feature that tracks a current location of a transportation vehicle via a base station having an established wireless connection with the modem, which is the first base station 398a in FIG. 3D, and wirelessly receive the travel information with the current location information from the external device to determine the position information. For example, the aircraft 396 may be able to access ADSB data from the external device on the ground via the first base station 398a, where the aircraft 396 regularly broadcasts the ADSB data to a device on the ground wirelessly.

In an aspect, the seat electronic device may be designated as a local server for determining the position information for two or more seat electronic devices of the group of seat electronic devices. In this aspect, the seat electronic device may transmit the position information to the two or more seat electronic devices of the group of seat electronic devices (e.g., using the position determination module 382 or 383, via the communication interface 378 or 328). For example, it may be beneficial to designate one seat electronic device as a local server that provides the same position information to other seat electronic devices, in order to display the same position information at various seat devices and/or PEDs. In an aspect, the seat electronic device may be designated as the local server for the two or more seat electronic devices of the group of seat electronic devices based on a capacity and/or capability of the seat electronic device. For example, if one seat electronic device is coupled to a location estimation device and/or a wireless modem and other seat electronic are not, the seat electronic device coupled to the location estimation device and/or the wireless modem may be designated as the local server. In an example, if one seat electronic device has a higher capacity (e.g., with a faster processor and/or a larger memory size) than other seat electronic devices, the seat electronic device with the higher capacity may be designated as the local server. In another example, if all seat electronic devices have the same or similar capacity, then one of the seat electronic devices may be selected randomly as the local server.

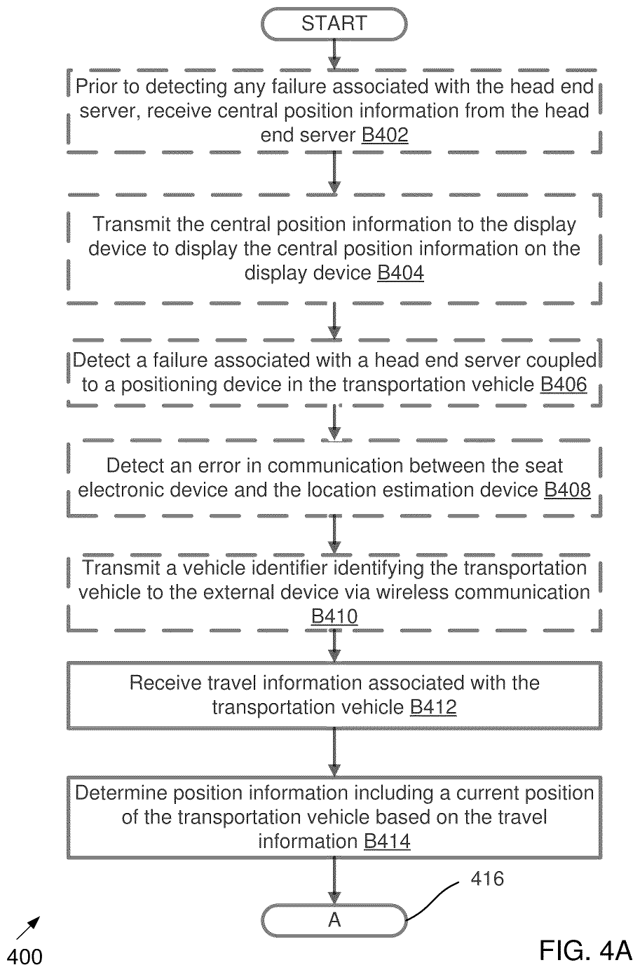

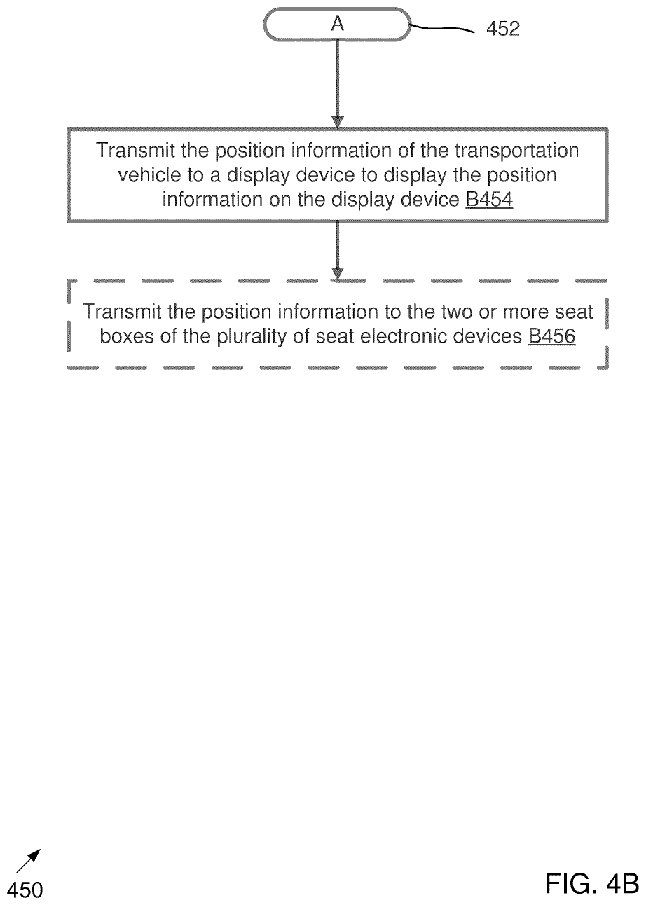

Process Flow: FIG. 4A shows a process 400 for providing a position of a transportation vehicle by a seat electronic device associated with at least one seat in the transportation vehicle, according to one aspect of the present disclosure. The seat electronic device may be a seat box such as the seat box 370 of FIG. 3A or may be a seat device such as the seat device 326 of FIG. 3A. Process 400 may be executed by the position determination module 382 of the seat box 370 or the position determination module 383 of the seat device 326.

Process 400 begins in block B402, where, in an aspect, seat electronic device may receive central position information from a head end server, prior to detecting any failure associated with the head end server, where the central position information indicates a position of the transportation vehicle. In block B404, in an aspect, the seat electronic device may transmit the central position information to the display device to display the central position information on the display device. For example, in an aspect, as discussed above, when the head end server is available without any failure, the seat electronic device may rely on the head end server to display a position of the transportation vehicle, by receiving the central position information from the head end server and providing the central position information to a display device.

In block B406, in an aspect, the seat electronic device may detect a failure associated with a head end server coupled to a positioning device in the transportation vehicle. In an aspect, the head end server may be a centralized server connected to the plurality of seat electronic devices and is configured to communicate a position of the transportation vehicle from the positioning device to the plurality of seat electronic devices to enable the plurality of seat electronic devices to provide the position of the transportation vehicle to display devices connected to the plurality of seat electronic devices. For example, as discussed above, the seat electronic device may detect the failure associated with the head end server, if the seat electronic device cannot communicate with the head end server and/or cannot receive the position of the transportation vehicle from the head end server.

In block B408, in an aspect, the seat electronic device may detect an error in communication between the seat electronic device and the location estimation device. For example, as discussed above, the seat electronic device may detect the error when the seat electronic device is not be able to receive the travel information from the location estimation device, e.g., due to errors associated with the location estimation device and/or a connection to the location estimation device.

In block B410, in an aspect, the seat electronic device may transmit a vehicle identifier identifying the transportation vehicle to the external device via wireless communication. In an aspect, the external device may exist outside of the transportation vehicle and separate from the transportation vehicle, and the seat electronic device may be configured to communicate with the external device via wireless communication. For example, as discussed above, the seat electronic device may transmit a vehicle identifier (e.g., aircraft tail number) to an external device apart from the transportation device, such that the seat electronic device may receive information from the external device based on the vehicle identifier.

In block B412, the seat electronic device receives travel information associated with the transportation vehicle, where the travel information is received from at least one of a location estimation device coupled to the seat electronic device, an external device independent from the transportation vehicle, or at least one second seat electronic device of a plurality of seat electronic devices.

In an aspect, the location estimation device may be a GPS tracking device coupled to the seat electronic device in the transportation vehicle, where the GPS tracking device is configured to measure a position of the transportation vehicle and to communicate the travel information indicating the position of the transportation vehicle to the seat electronic device. For example, as discussed above, the seat electronic device may be coupled to the GPS tracking device, such that the seat electronic device may receive a current position directly from the GPS tracking device, without relying on the head end server.

In an aspect, each of the at least one second seat electronic device may be coupled to a respective GPS tracking device and may be configured to receive the travel information from the respective GPS tracking device to relay the travel information to the seat electronic device. For example, the seat electronic device may rely on another seat electronic device coupled to a GPS tracking device to receive the current position of the transportation device. This feature may be beneficial if the seat electronic device is not be directly coupled to a GPS tracking device or if there is an error in receiving information from a GPS tracking device coupled to the seat electronic device.

In an aspect, the receiving the travel information comprises receiving the travel information including a plurality of position values associated with a position of the transportation vehicle from the plurality of seat electronic devices, the plurality of seat electronic devices being coupled to a plurality of GPS tracking devices to receive the plurality of position values from the plurality of GPS tracking devices, respectively. In this aspect, the determining the position information comprises selecting a median position value of the plurality of position values to determine the position information.

In an aspect, the seat electronic device receiving the travel information at block B412 may receive the travel information from at least one of the external device or the at least one second seat electronic device in response to detecting the error at block B408. Hence, for example, if the error in communication between the seat electronic device and the location estimation device is detected in block B408, receiving the travel information at block B412 may include receiving the travel information from at least one of the external device or the at least one second seat electronic device in response to detecting the error at block B408. For example, as discussed above, when this type of error occurs, the seat electronic device may receive the travel information from another source different from the location estimation device, such as the external device and/or the at least one second seat electronic device.

In an aspect, the seat electronic device receiving the travel information at block B412 may receive the travel information based on the vehicle identifier. Hence, for example, after the seat electronic device transmits the vehicle identifier at block B410, the receiving the travel information at block B412 may include receiving the travel information based on the vehicle identifier. As such, for example, the seat electronic device may rely on the external device to receive the travel information and determine the position information based on the travel information.

In block 414, the seat electronic device determines position information including a current position of the transportation vehicle based on the travel information.

In an aspect, the seat electronic device determining the position information in block B414 may determine the position information in response to detecting the failure associated with the head end server at block B406. In an aspect, the position information determined in response to detecting the failure associated with the head end server may be transmitted to the display device to display the position information after detecting the failure in block B406. For example, as discussed above, if the failure associated with the head end server is detected, the head end server may no longer be able to provide the central position information. Thus, the seat electronic device may determine the position information and provide the position information to display, without relying on the head end server, when the failure associated with the head end server is detected.

In an aspect, the wireless communication may be provided via a wireless communication modem connected to the seat electronic device, the wireless communication modem being configured to establish a wireless connection with at least one wireless base station of a plurality of wireless base stations on a ground outside of the transportation vehicle. In this aspect, the seat electronic device receiving the travel information at block B412 may receive the travel information including a location of the at least one wireless base station having the wireless connection established with the wireless communication modem connected to the seat electronic device, where the position information is determined based on the location of the at least one wireless base station. For example, as discussed above, there may be multiple base stations spread out in various locations. A wireless modem generally establishes a wireless communication with a base station closest to the wireless modem. By determining a location of the base station that has established the wireless connection with the modem of the seat electronic device, the seat electronic device may estimate the current position of the transportation device.

In an aspect, the travel information received from at least one of the external device or the at least one second seat electronic device may include at least one of a departure location of the transportation vehicle, a destination location of the transportation vehicle, or a travel route of the transportation vehicle. In an aspect, the seat electronic device determining the position information may estimate a position of the transportation vehicle based on at least one of a last-known position of the transportation vehicle, the departure location, the destination location, the travel route, an elapsed time since a departure from the departure location, and a remaining time to the destination location, where the position information is based on the estimated position. For example, as discussed above, the seat electronic device may receive this travel information from the external device and/or from a different seat electronic device in the local network of the seat electronic devices, where the different seat electronic device has received this travel information from the external device. As discussed above, assuming that the transportation vehicle does not deviate significantly from the travel route, the current position of the transportation vehicle may be estimated based on at least one of the last-known position of the transportation vehicle, the departure location, the destination location, the travel route, the elapsed time since a departure from the departure location, and the remaining time to the destination location.

At 416, the process 300 continues in FIG. 4B, as described below.

FIG. 4B shows a process flow diagram 450 by the seat electronic device, continuing from FIG. 4A, according to an aspect of the present disclosure. At 452, the process 450 continues from the process 400 of FIG. 4A. As discussed above, the seat electronic device may be a seat box such as the seat box 370 of FIG. 3A or may be a seat device such as the seat device 326 of FIG. 3A. Process 450 may be executed by the position determination module 382 of the seat box 370 or the position determination module 383 of the seat device 326.

In block B454, the seat electronic device transmits the position information of the transportation vehicle to a display device to display the position information on the display device. In an aspect, the seat electronic device is included in the plurality of seat electronic devices connected to one another to form a local network of seat electronic devices. For example, as discussed above, the seat electronic device may provide the position information to a display device of a seat device and/or to a display device of a PED to display the position information.

In block B456, in an aspect where the seat electronic device is designated as a local server for determining the position information for two or more seat electronic devices of the plurality of seat electronic devices, the seat electronic device may transmit the position information to the two or more seat electronic devices of the plurality of seat electronic devices. In an aspect, the seat electronic device may be designated as the local server for the two or more seat electronic devices of the plurality of seat electronic devices based on a capacity of the seat electronic device. For example, as discussed above, it may be beneficial to designate one seat electronic device as a local server that provides the same position information to other seat electronic devices, in order to display the same position information at various seat devices and/or PEDs. For example, as discussed above, the seat electronic device may be designated as the local server for the two or more seat electronic devices of the group of seat electronic devices based on a capacity and/or capability of the seat electronic device.

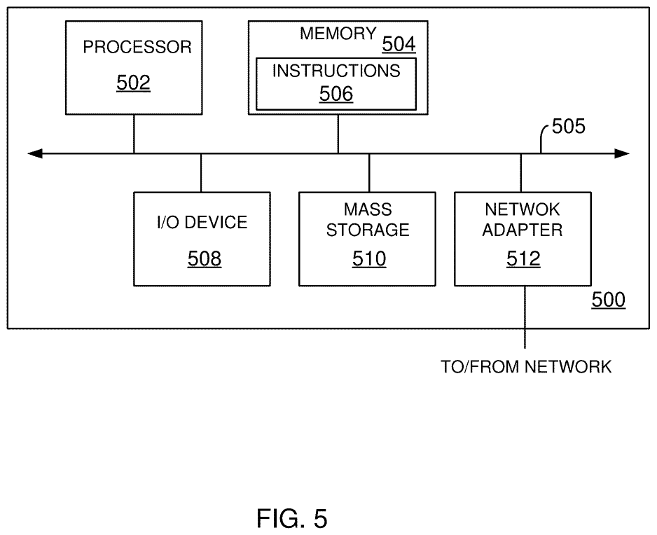

Processing System: FIG. 5 is a high-level block diagram showing an example of the architecture of a processing system 500 that may be used according to one aspect. The processing system 500 can represent CMD 360, media server 112, computing system 106/107, WAP 130, onboard management system 344, seat device 326, seat box 370, or any user device (PED 302) that attempts to interface with a vehicle computing device. Note that certain standard and well-known components which are not germane to the present aspects are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The processor(s) 502 are the central processing units (CPUs) of the processing system 500 and, thus, control its overall operation. In certain aspects, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random-access memory (RAM), read-only memory (ROM), flash memory, or the like, or a combination of such devices. Memory 504 includes the main memory of the processing system 500. Instructions 506 may be used to the process steps of FIG. 4A and FIG. 4B executed by the position determination module 382, the position determination module 383, and/or the data 352, described above.

Also connected to the processors 502 through the bus system 505 are one or more internal mass storage devices 510, and a network adapter 512. Internal mass storage devices 510 may be or may include any conventional medium for storing large volumes of data in a non-volatile manner, such as one or more magnetic or optical based disks, flash memory, or solid-state drive.

The network adapter 512 provides the processing system 500 with the ability to communicate with remote devices (e.g., over a network) and may be, for example, an Ethernet adapter or the like.

The processing system 500 also includes one or more input/output (I/O) devices 508 coupled to the bus system 505. The I/O devices 508 may include, for example, a display device, a keyboard, a mouse, etc. The I/O device may be in the form of a handset having one or more of the foregoing components, such as a display with a real or virtual keyboard, buttons, and/or other touch-sensitive surfaces.

Thus, methods and systems for providing a position of a transportation vehicle by a seat electronic device associated with at least one seat in the transportation vehicle have been described. Note that references throughout this specification to “one aspect” (or “embodiment”) or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

1. A method of providing a position of a transportation vehicle by a seat electronic device associated with at least one seat in the transportation vehicle, the method comprising:
receiving travel information associated with the transportation vehicle, wherein the travel information is received from at least one of a location estimation device coupled to the seat electronic device, an external device independent from the transportation vehicle, or at least one second seat electronic device of a plurality of seat electronic devices;
determining position information including a current position of the transportation vehicle based on the travel information; and
transmitting the position information of the transportation vehicle to a display device to display the position information on the display device,
wherein the seat electronic device is included in the plurality of seat electronic devices connected to one another to form a local network of seat electronic devices.

2. The method of claim 1, wherein the location estimation device is a global positioning system (GPS) tracking device coupled to the seat electronic device in the transportation vehicle, the GPS tracking device configured to measure a position of the transportation vehicle and to communicate the travel information indicating the position of the transportation vehicle to the seat electronic device.

3. The method of claim 1, wherein each of the at least one second seat electronic device is coupled to a respective global positioning system (GPS) tracking device and is configured to receive the travel information from the respective GPS tracking device to relay the travel information to the seat electronic device.

4. The method of claim 1, wherein the receiving the travel information comprises receiving the travel information including a plurality of position values associated with a position of the transportation vehicle from the plurality of seat electronic devices, the plurality of seat electronic devices being coupled to a plurality of global positioning system (GPS) tracking devices to receive the plurality of position values from the plurality of GPS tracking devices, respectively, and
wherein the determining the position information comprises selecting a median position value of the plurality of position values to determine the position information.

5. The method of claim 1, further comprising:
detecting an error in communication between the seat electronic device and the location estimation device,
wherein receiving the travel information comprises receiving the travel information from at least one of the external device or the at least one second seat electronic device in response to detecting the error.

6. The method of claim 1, wherein the external device exists outside of the transportation vehicle and separate from the transportation vehicle, and
wherein the seat electronic device is configured to communicate with the external device via wireless communication.

7. The method of claim 6, further comprising:
transmitting a vehicle identifier identifying the transportation vehicle to the external device via wireless communication,
wherein the travel information is received based on the vehicle identifier.

8. The method of claim 6, wherein the wireless communication is provided via a wireless communication modem connected to the seat electronic device, the wireless communication modem being configured to establish a wireless connection with at least one wireless base station of a plurality of wireless base stations on a ground outside of the transportation vehicle.

9. The method of claim 8, wherein the receiving the travel information comprises receiving the travel information including a location of the at least one wireless base station having the wireless connection established with the wireless communication modem connected to the seat electronic device, and
wherein the position information is determined based on the location of the at least one wireless base station.

10. The method of claim 1, wherein the travel information received from at least one of the external device or the at least one second seat electronic device includes at least one of a departure location of the transportation vehicle, a destination location of the transportation vehicle, or a travel route of the transportation vehicle.

11. The method of claim 10, wherein the determining the position information comprises:
estimating a position of the transportation vehicle based on at least one of a last-known position of the transportation vehicle, the departure location, the destination location, the travel route, an elapsed time since a departure from the departure location, and a remaining time to the destination location,
wherein the position information is based on the estimated position.

12. The method of claim 1, further comprising:
detecting a failure associated with a head end server coupled to a positioning device in the transportation vehicle, wherein the head end server is a centralized server connected to the plurality of seat electronic devices and is configured to communicate a position of the transportation vehicle from the positioning device to the plurality of seat electronic devices to enable the plurality of seat electronic devices to provide the position of the transportation vehicle to display devices connected to the plurality of seat electronic devices,
wherein the position information is determined in response to detecting the failure associated with the head end server.

13. The method of claim 12, further comprising:
prior to detecting the failure associated with the head end server, receiving central position information from the head end server, the central position information indicating a position of the transportation vehicle; and
transmitting the central position information to the display device to display the central position information on the display device,
wherein the position information determined in response to detecting the failure associated with the head end server is transmitted to the display device to display the position information after detecting the failure.

14. The method of claim 1, wherein the seat electronic device is designated as a local server for determining the position information for two or more seat electronic devices of the plurality of seat electronic devices, and
wherein the method further comprises:
transmitting the position information to the two or more seat electronic devices of the plurality of seat electronic devices.

15. The method of claim 14, wherein the seat electronic device is designated as the local server for the two or more seat electronic devices of the plurality of seat electronic devices based on a capacity of the seat electronic device.

16. A non-transitory machine-readable storage medium for a seat electronic device associated with at least one seat in a transportation vehicle, the machine-readable storage medium having stored thereon instructions for performing a method, comprising machine executable code which when executed by at least one machine, causes the machine to:
receive travel information associated with the transportation vehicle, wherein the travel information is received from at least one of a location estimation device coupled to the seat electronic device, an external device independent from the transportation vehicle, or at least one second seat electronic device of a plurality of seat electronic devices;
determine position information including a current position of the transportation vehicle based on the travel information; and
transmit the position information of transportation vehicle to a display device to display the position information on the display device,
wherein the seat electronic device is included in the plurality of seat electronic devices connected to one another to form a local network of seat electronic devices.

17. The machine-readable storage medium of claim 16, wherein the external device exists outside of the transportation vehicle and separate from the transportation vehicle, and
wherein the seat electronic device is configured to communicate with the external device via wireless communication.

18. The machine-readable storage medium of claim 16, wherein the travel information received via at least one of the external device or the at least one second seat electronic device includes at least one of a departure location of the transportation vehicle, a destination location of the transportation vehicle, or a travel route of the transportation vehicle.

19. The machine-readable storage medium of claim 16, wherein the machine executable code further causes the machine to:
detect a failure associated with a head end server coupled to a positioning device in the transportation vehicle, wherein the head end server is a centralized server connected to the plurality of seat electronic devices and is configured to communicate a position of the transportation vehicle from the positioning device to the plurality of seat electronic devices to enable the plurality of seat electronic devices to provide the position of the transportation vehicle to display devices connected to the plurality of seat electronic devices,
wherein the position information is received in response to detecting the failure.

20. A seat electronic device associated with at least one seat in a transportation vehicle, comprising:
a memory containing machine readable medium comprising machine executable code having stored thereon instructions; and a processor coupled to the memory to execute the machine executable code to:
receive travel information associated with the transportation vehicle, wherein the travel information is received from at least one of a location estimation device coupled to the seat electronic device, an external device independent from the transportation vehicle, or at least one second seat electronic device of a plurality of seat electronic devices;
determine position information including a current position of the transportation vehicle based on the travel information; and
transmit the position information of transportation vehicle to a display device to display the position information on the display device,
wherein the seat electronic device is included in the plurality of seat electronic devices connected to one another to form a local network of seat electronic devices.
